(19) United States
(12) Patent Application Publication
(10) Pub. No.: US 2004/0172233 A1
(43) Pub. Date: Sep. 2, 2004

(54) Semiconductor integrated circuit device and microcomputer development assisting apparatus

(76) Inventors: Naoki Ito, Nukata-gun (JP); Kyouichi Suzuki, Toyohashi-city (JP); Hideaki Ishihara, Okazaki-city (JP)

Correspondence Address: POSZ & BETHARDS, PLC, 11250 ROGER BACON DRIVE, SUITE 10, RESTON, VA, 20190, US

(21) Appl. No.: 10/786,136

(22) Filed: Feb. 26, 2004

(30) Foreign Application Priority Data
Feb. 28, 2003 (JP) 2003-53858
Jan. 14, 2004 (JP) 2004-6828

(51) Int. Cl. G06F 9/455

(52) U.S. Cl. 703/25; 713/1

(57) ABSTRACT

Where instruction data to enable a stop control is stored in an operation setting register that is provided in a peripheral module in an evaluation chip, a stop control circuit of the peripheral module stops the progress of an operation of a functional circuit until a CPU completes processing of a monitor program that is performed in response to a break interrupt request. None of the operation setting register, the stop control circuit, and an interface circuit are reset by a reset signal supplied from a circuit board as a target system. The CPU directly starts execution of a user program without starting the monitor program.

### CROSS REFERENCE TO RELATED APPLICATION

This application is based on and incorporates herein by reference Japanese Patent Applications No. 2003-53658 filed on Feb. 28, 2003 and No. 2004-6828 filed on Jan. 14, 2004.

### FIELD OF THE INVENTION

The present invention relates to a semiconductor integrated circuit device for emulating the operation of a one-chip microcomputer and a microcomputer development assisting apparatus having the semiconductor integrated circuit device.

### BACKGROUND OF THE INVENTION

In an emulator disclosed in JP-A-8-30478, a user program is started without starting firmware after power-on resetting or forcible resetting, and debugging is performed without impairing real-time correspondence in operation between the emulator and a CPU that is provided in an application system. This emulator has an advantage that in a multi-CPU application system having a plurality of CPUs a program can be started at the same time as the CPUs and debugging can be performed immediately after resetting of an evaluation chip.

In an in-circuit emulator disclosed in Japanese Patent No. 3,410,023, in response to input of a re-execution instruction that occurs after completion of processing that was performed in response to an interrupt that occurred in a stop mode, a return address that is saved in a stack area is written into a dummy return address, an instruction of the stop mode is written into the area of the dummy return address, and an instruction to unconditionally branch to the return address of a main routine is written into the area of the next address. In this manner, a stop mode state in which a user program was stopped is restored.

FIG. 7 shows the configuration of an evaluation chip 1 that is incorporated in an ICE (in-circuit emulator; microcomputer development assisting apparatus). Like a target chip (not shown), the evaluation chip 1 is equipped with a CPU 2 and various peripheral modules 3. The evaluation chip 1 is also equipped with an interface circuit 4 for interfacing between the CPU 2 and the ICE main body (not shown). Each peripheral module 3 has registers 3a, 3b, such as a data register, a status register and an operation setting register. The interface circuit 4 also has registers 4a, 4b, such as a data register, a status register and an operation setting register.

In this evaluation chip 1, a reset signal RST that is generated by manipulating the ICE is the same as a reset signal that is generated in a target system. The reset signal RST is supplied to the CPU 2, peripheral modules 3 and interface circuit 4.

For example, when the reset signal is generated in the target system, not only the CPU 2 and the peripheral modules 3 but also the interface circuit 4 is reset. As a result, a monitor program for resetting (i.e., initializing) the interface circuit 4 needs to be started again every time resetting is done. Deviation occurs between operation timing of a case that a reset signal is generated in the actual target system and operation timing of a case that a reset signal is generated while emulation is performed by using the evaluation chip 1.

### SUMMARY OF THE INVENTION

The present invention therefore has an object to provide a semiconductor integrated circuit device capable of correctly emulating an operation to be performed immediately after generation of a reset signal. The present invention also relates to a microcomputer development assisting apparatus having the semiconductor integrated circuit device.

According to the invention, when receiving a first reset signal, a CPU starts execution of a user program from a vector address corresponding to the reset vector address. When receiving a second reset signal, the CPU starts execution of a monitor program from a vector address that is different from the vector address corresponding to the reset vector address. An interface circuit is not reset by the first reset signal. Therefore, when, for example, the first reset signal is supplied from a circuit board as a target system, execution of the user program can be started directly without the need for resetting (initializing) the interface circuit or newly starting the monitor program, i.e., under the control of the monitor program that has already been started.

With this measure, operation timing of a case that a reset signal is generated during emulation using a semiconductor integrated circuit device is made identical to operation timing of a case that a reset signal is generated in the actual target system. The operation that is performed immediately after the generation of the reset signal can be evaluated correctly. Further, the entire semiconductor integrated circuit device can be reset by applying a second reset signal to it,

### BRIEF DESCRIPTION OF THE DRAWINGS

The above and other objects, features and advantages of the present invention will become more apparent from the following detailed description made with reference to the accompanying drawings. In the drawings:

FIG. 1 is a circuit diagram showing an evaluation system according to a first embodiment of the present invention;

FIG. 2A is a flowchart showing a process that is executed after resetting of the evaluation system;

FIG. 2B is a flowchart showing a process that is executed by a CPU;

FIGS. 3A and 3B are timing charts showing operations of the CPU and a timer;

FIG. 4 is a circuit diagram showing a break request processing circuit used in an evaluation system according to a second embodiment of the invention;

FIGS. 5A and 5B are timing charts showing operations that are performed when a break request signal is input in a low power consumption operation mode;

FIGS. 6A and 6B are timing charts showing operations that are performed when a break request signal is input in a low power consumption operation mode; and

FIG. 7 is a circuit diagram schematically showing an evaluation system according to a prior art.

### DESCRIPTION OF THE PREFERRED EMBODIMENTS

### First Embodiment

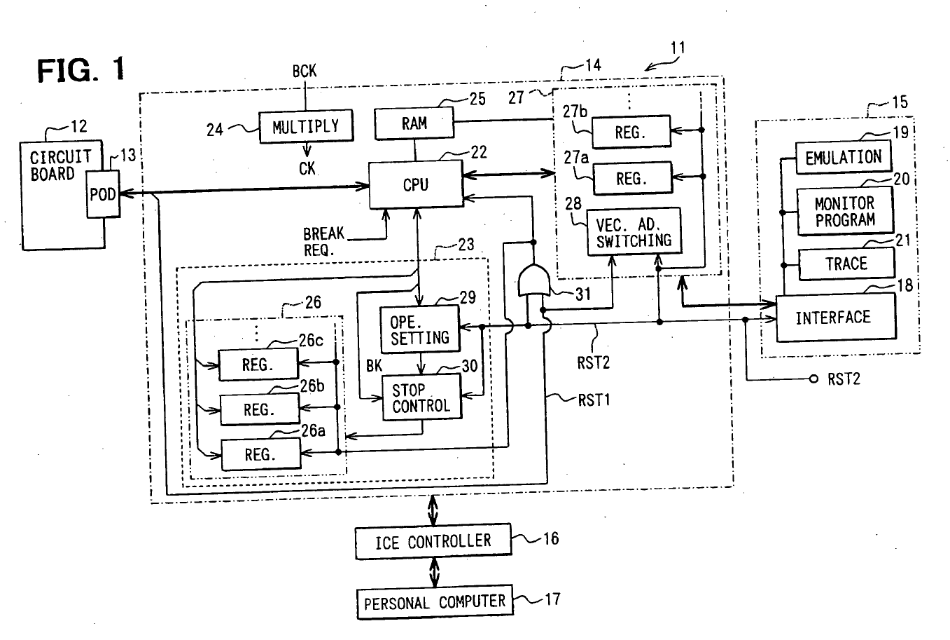

Referring first to FIG. 1, a circuit board 12 is used as a target system. On this board 12, a one-chip microcomputer as a subject of evaluation is mounted, and is used being accommodated in, for example, an ECU (electric control unit) of a vehicle. An in-circuit emulator (ICE) 11 as a microcomputer development assisting device is used for emulating the operation of the microcomputer.

Instead of the evaluation subject microcomputer, a socket (not shown) is mounted on the circuit board 12 at a position where the microcomputer should be mounted. A probe (POD) 13 that is located at the tip of an emulation cable extending from the main body of ICE 11 is connected to the socket. An evaluation chip 14 is electrically connected to the circuit board 12 via the emulation cable and the POD 13.

The ICE 11 is composed of the evaluation chip 14 (semiconductor integrated circuit device) for emulating the operation of the microcomputer, a memory unit 15, and a personal computer 17 (host) that is connected to the evaluation chip 14 via an ICE controller 16. The memory unit 15 is equipped with an interface circuit 18 for exchanging data with the evaluation chip 14 at high speed. An emulation memory 19, a monitor program memory 20, and a trace memory 21 are connected to the interface circuit 18.

The emulation memory 19 is a memory (RAM) for storing a user program that is downloaded from the personal computer 17. The monitor program memory 20 is a memory for storing a monitor program (evaluation program or emulation program) to be executed by the evaluation chip 14 and is a ROM or a RAM. In case that the emulation memory 19 is a RAM, a monitor program is downloaded from the personal computer 17 before execution of emulation.

When emulation is performed in a trace mode, executed instructions are written into the trace memory 21 in the order of execution and stored therein. The trace memory 21 also stores information relating to a program counter and internal registers such as an interrupt request flag register and an instruction execution permission flag register all of which are incorporated in the evaluation chip 14.

Like the microcomputer to be mounted on the circuit board 12, the evaluation chip 14 is equipped with a CPU 22, various peripheral circuit modules 23 (only one of those is shown in FIG. 1), a frequency multiplier circuit 24, and a RAM 25. Each peripheral module 23 is equipped with a functional circuit 26 that serves as a timer, a counter, an input/output port, a serial communication unit, an A/D converter, a D/A converter, or the like, and various registers 26a, 26b, 26c, such as a data register and an operation setting register, are connected to the CPU 22 via an address bus and a data bus. The frequency multiplier circuit 24 multiplies the frequency of a basic clock BCK that is input from the outside of the evaluation chip 14 and supplies a resulting clock CK to the CPU 22, the peripheral modules 23, an interface circuit 27, etc.

The evaluation chip 14 is equipped with the interface circuit 27 for enabling high-speed data exchange between the CPU 22 and the memory unit 15. The interface circuit 27 is equipped with registers 27a, 27b for setting, for example, an operation mode relating to input and output. The interface circuit 27 is also equipped with a vector address switching circuit 28 for controlling switching for a reset vector that is output from the CPU 22 when the CPU 22 is reset.

Parts of the peripheral modules 23, such as a timer and an a synchronous serial communication unit, where no internal error occurs even if their operation is stopped temporarily are equipped with an operation setting register 29 and a stop control circuit 30. The stop control circuit 30 functions to stop the progress of operation of the functional circuit 26 of the peripheral module 23, while receiving a break processing signal BK from the CPU 22. Where the functional circuit 26 is a timer, for example, a timer operation of the functional circuit 26 is stopped while the stop control circuit 30 is receiving a break processing signal BK and a timer value immediately before the input of the break processing signal BK is retained there.

The CPU 22 starts to output a break processing signal BK when receiving a break interrupt request (break request signal) during execution of a user program, and continues to output it until the break interrupt processing is finished.

The operation setting register 29 stores instruction data indicating whether to enable or disable the function of the stop control circuit 30. The instruction data is written by the CPU 22. The stop control circuit 30 performs the above stop control only if the instruction data in the operation setting register 29 is “enable.”

Two systems of reset signals RST1 and RST2 are input to the evaluation chip 14. The first reset signal RST1 is a target reset signal that is input from the circuit board 12 via the POD 13 and the emulation cable. The second reset signal RST2 is an ICE reset signal that is input from the main body of ICE 11 in response to a reset manipulation of the user or the like.

Reset signals RST1 and RST2 are supplied to the reset terminals of the CPU 22 and the functional circuit 26 (registers 26a, 26b, 26c, etc.) of each peripheral module 23 via an OR circuit 31. That is, the CPU 22 and the functional circuit 26 of each peripheral module 23 can be reset by either of reset signals RST1 and RST2. On the other hand, the operation setting register 29 and the stop control circuit 30 of each peripheral module 23, the interface circuit 18, and the interface circuit 27 (registers 27a, 27b, 27c, etc.) can be reset only by a reset signal RST2.

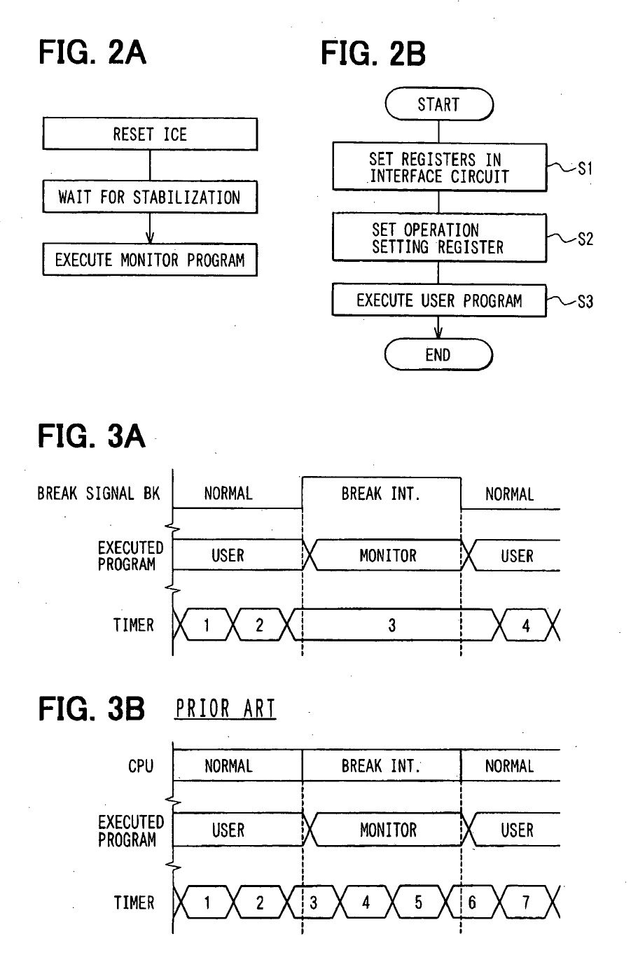

Next, the operation of this embodiment will be described with reference to FIGS. 2A and 2B and FIGS. 3A and 3B.

The user starts ICE software on the personal computer 17 and downloads a monitor program into the monitor program memory 20 of the ICE 11. Then, the user downloads, into the emulation memory 19, a user program as a subject of evaluation that has been developed for the target system. If a reset manipulation is performed on the main body of ICE 11 in this state, the reset signal RST2 is generated and the entire evaluation chip 14 and the interface circuit 18 are reset.

As shown in FIG. 2A, after waiting for stabilization, that is, after a lapse of a prescribed oscillation stabilization waiting time, the CPU 22 is started and outputs a reset vector to the vector address switching circuit 28 via the address bus. A delay circuit (not shown) provided inside the evaluation chip 14 serves for this purpose. Reset signals RST1 and RST2 are input to the vector address switching circuit 28.

The vector address switching circuit 28 performs vector address switching depending on the kind of reset signal (target reset or ICE reset). Since the reset signal concerned is there set signal RST1 (ICE resets, the vector address switching circuit 28 outputs a vector address indicating a head address of the monitor program instead of a vector address (of the user program) that is supplied from the CPU 22. As a result, the CPU 22 starts to execute the monitor program.

FIG. 2B is a flowchart showing a process that is executed by the CPU 22. According to the started monitor program, the CPU 22 writes prescribed operation setting data to the registers 27a, 27b of the interface circuit 27 (step S1). Then, the CPU 22 writes, to the operation setting register 29 of each peripheral module 23, instruction data for enabling the function of the stop control circuit 30 (step 52). After completion of the above initial setting, the CPU 22 starts execution of the user program (step 53). It is noted that according to ordinary user programs the CPU 22, the functional circuits 26 (registers 26a, 26b, 26c), the RAM 25, etc. are subjected to initial setting.

Subsequently, the user (i.e., an evaluation operator) debuge the target system while setting break conditions. In addition to a break address, such conditions as an instruction fetch cycle/data access cycle, a read cycle/write cycle, and byte access/word access can be set as the break conditions.

If a preset break condition is satisfied during execution of an instruction, a break interrupt request is sent to the CPU 22. Upon receiving that interrupt request, the CPU 22 moves to execution of the monitor program. In this state, the user can check values etc. stored in the registers of the CPU 22, the RAM 25, and the registers 26a, 26b and 26c on the monitor screen of the personal computer 17 while manipulating the personal computer 17. After completion of the check, the user inputs a “go” command through the personal computer 17, whereupon the CPU 22 returns from the interrupt processing and starts execution of the user program again.

FIG. 3A is a timing chart showing operations of the CPU 22 and the peripheral module 23 that is assumed to be a timer, and

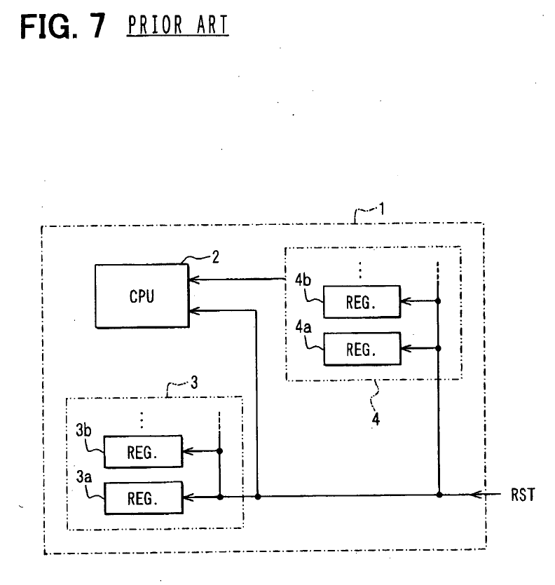

FIG. 35 is a corresponding timing chart for the evaluation chip 1 shown in FIG. 7. As shown in FIG. 3A, the CPU 22 outputs a H-level break processing signal BK during a period from reception of the break interrupt request to return (i.e., during execution of the monitor program).

Since permission instruction data has been written into the operation setting register 29 of the peripheral module 23, the stop control circuit 30 stops the timer operation of the timer when the break processing signal BK has changed to the H level. At this time, a timer value immediately before the break processing signal BK has changed to the H level is maintained.

When the break processing signal BK has returned to the L level, the stop control circuit 30 causes the timer to restart the timer operation from the current value. If instruction data for disabling the function of the stop control circuit 30 is stored in the operation setting register 29, the stop control circuit 30 does not stop the progress of the operation of the functional circuit 26 even if receiving the H-level break processing signal BK. Therefore, the timer value continues to increase as shown in FIG. 3B.

If the reset signal RST1 is supplied from the circuit board 12 in the above debugging work, the CPU 22 and the functional circuit 26 (timer circuit) of each peripheral module 23 are reset. In this case, the vector address switching circuit 28 outputs, as it is, a vector address that is output from the CPU 22, that is, a vector address indicating a head address of the user program. As a result, the CPU 22 starts execution of the user program rather than the monitor program. The timing with which the user program starts to be executed in response to the reset signal RST1 is the same as the timing with which the user program starts to be executed by the actual target system after resetting.

The user program can directly start to be executed after target resetting without intervention of the monitor program, because none of the operation setting register 29, the stop control circuit 30 and the interface circuits 18 and 27 are reset by the reset signal RST1. At the time of power-on or system resetting of the ICE 11, the entire evaluation chip 14 is reset and the monitor program is started in the above manner.

As described above, according to this embodiment, two system reset signals RST1 and RST2 are input to the evaluation chip 14. The CPU 22 starts execution of the user program when receiving the reset signal RST1, and starts execution of the monitor program when receiving the reset signal RST2. The operation setting register 29 and the stop control circuit 30 of each peripheral module 23 are not reset by the reset signal RST1. Therefore, when the reset signal RST1 is supplied from the circuit board 12 as the target system, the user program can directly start to be executed without newly starting the monitor program, i.e., under the control of the monitor program that has already been started.

As a result, operation timing of a case that the reset signal RST1 is generated during emulation using the evaluation chip 14 is made identical to operation timing of a case that the reset signal is generated in the actual target system. The operation that is performed immediately after there setting can be evaluated correctly.

Where instruction data for enabling a stop control is stored in the operation setting register 29 that is provided in each peripheral module 23 of the evaluation chip 14, when the CPU 22 receives the break interrupt request the stop control circuit 30 of each peripheral module 23 stops the progress of operation of the functional circuit 26 until processing of the monitor program that is performed in response to the break interrupt request is finished. Therefore, by utilizing the monitoring function that is performed by the evaluation chip 14, the user can recognize operation states of the peripheral modules 23 easily and correctly at the time of reception of the break interrupt request.

If the break state is canceled and the CPU 22 returns to user program execution state that is established immediately before the reception of the break interrupt request, the functional circuit 26 restarts the operation that has been stopped. As a result, the execution of the user program by the CPU 22 and the operations of the peripheral modules 23 are restarted in synchronism with each other in such a manner that their continuity with the states immediately before the reception of the break interrupt request is secured. Therefore, the operation of the microcomputer can be emulated correctly with the operation continuity secured while breaks are inserted.

### Second Embodiment

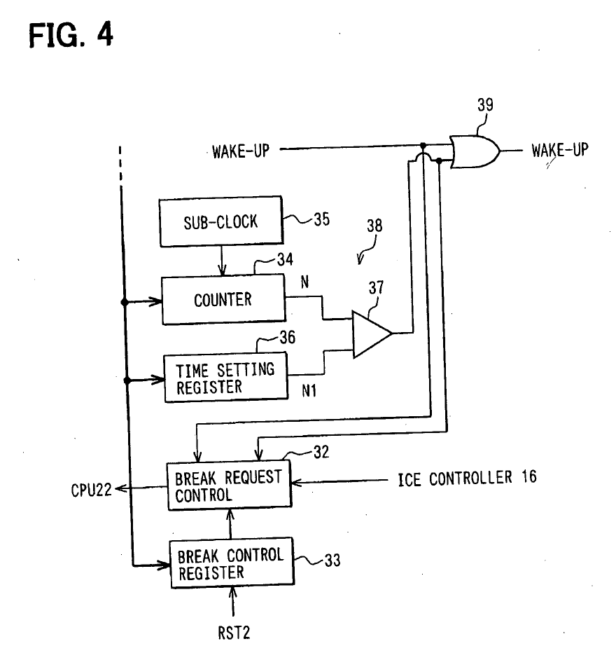

In this embodiment, a break request processing circuit shown in FIG. 4 is additionally provided in the evaluation chip 14. In addition to the normal operation mode in which the CPU 22 operates receiving the clock CK from the frequency multiplier circuit 24, the CPU 22 has a low power consumption operation mode (i.e., sleep mode) in which the CPU 22 stands by in a state that the supply of clock signal CK is stopped. In the low power consumption operation mode, the supply of clock signal CK is stopped and operation of the peripheral modules 23 is stopped.

The CPU 22 makes a transition to the low power consumption operation mode in response to an interrupt or the like, and returns to the normal operation mode (i.e., wakes up) upon occurrence of a wake-up event such as a communication or input capture. Incorporating wake-up registers (wake-up event flag registers) for storing information indicating a wake-up event that has occurred, the CPU 22 can recognize the wake-up event during execution of a program by referring to the wake-up registers and hence can perform processing in accordance with the wake-up event.

When receiving the break request signal from the ICE controller 16 in a period when the normal operation mode is established, a break request control circuit 32 immediately outputs the break request signal to the CPU 22 irrespective of the value of a break request control register 33.

On the other hand, if the break request signal is input from the ICE controller 16 in a period when the low power consumption operation mode is established and if “1” (enable) is stored in the break request control register 33, the break request control circuit 32 will output the break request signal to the CPU 22 when a certain wake-up signal is input later.

Conversely, if “0” (disable) is stored in the break request control register 33, the break request control circuit 32 immediately outputs the break request signal to the CPU 22 without performing such a break reservation control. The break request control circuit 32 is reset by the reset signal REST.

A wake-up signal generation circuit 38 is composed of a counter 34, a sub-clock generation circuit 35, a time setting register 36 and a comparator circuit 37, The counter 34 stops counting with the count kept at “0” in a period when the normal operation mode is established, and incrementally counts sub-clock pulses that are generated by the sub-clock generation circuit 35. The sub-clock generation circuit 35 is a CR oscillation circuit that continues to oscillate even in the low power consumption operation mode.

The time setting register 36 operating as a setting information storage circuit stores a set count N1 that corresponds to a set time T1. The comparator circuit 37 outputs a wake-up signal when the count N of the counter 34 has become greater than or equal to the set count N1.

A wake-up signal of a communication, input capture, or the like and a wake-up signal from the comparator circuit 37 are input to an OR circuit 39, and a unified wake-up signal that is output from the OR circuit 39 is supplied to the CPU 22. The wake-up signal generation circuit 38 is not necessary in the case where the ICE 11 does not manage timeout for the input of a break command.

Next, the operations and the advantages of this embodiment will be described.

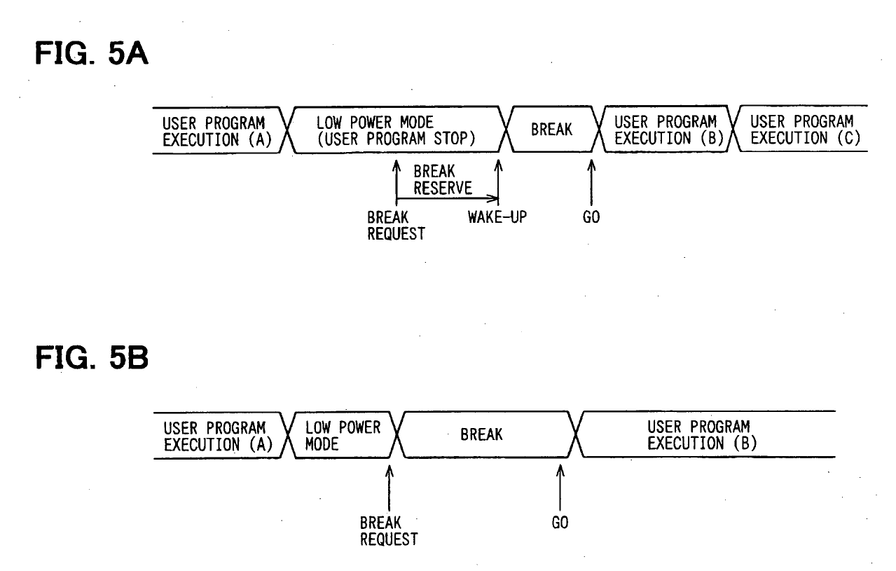

First, the operation of the break request control circuit 32 will be described with reference to timing charts of FIG. 5A and 5B. FIG. 5A is a timing chart of a case that “1” (break reservation control is enabled) is stored in the break request control register 33, and FIG. 5B is a timing chart of a case that “0” (break reservation control is disabled) is stored in the break request control register 33.

(a) Case that break reservation control is enabled:

If a break request signal is input from the ICE controller 16 after a transition was made to the low power consumption operation mode in a state that the CPU 22 was executing the user program (execution state A), the break request control circuit 32 reserves the break request signal until a certain wake-up event occurs. Upon occurrence of the wake-up signal, the break request control circuit 32 outputs the break request signal to the CPU 22, whereupon the CPU 22 makes a transition to the break state.

If the user (i.e., evaluation operator) thereafter inputs a “go” command through the personal computer 17, the CPU 22 identifies the wake-up event by referring to the wake-up registers and performs processing that corresponds to the wake-up event (execution state B). When returning from this state, the CPU 22 restarts the execution of the user program (execution state C) from processing that was interrupted in the execution state A.

(b) Case that break reservation control is disabled:

If a break request signal is input from the ICE controller 16 after a transition was made to the low power consumption operation mode, the break request control circuit 32 immediately outputs the break request signal to the CPU 22, whereupon the CPU 22 makes a transition to a break state. If the user (i.e., evaluation operator) thereafter inputs a “go” command through the personal computer 17, the CPU 22 refers to the wake-up registers. However, no wake-up event has occurred, the CPU 22 makes a transition to user program error processing. Where the user program is formed so that a state that no wake-up event has occurred is not regarded as an error, the CPU 22 may return to an execution state C as in case (a).

As described above, where the break reservation control in the low power consumption operation mode is enabled, the CPU 22 makes a transition to a break state after a certain wake-up event occurs. Therefore, in wake-up processing that is performed in response to input of a “go” command, a state that a certain bit (i.e., wake-up event flag) of a certain wake-up register is set is established. Therefore, the user can write a program without the need for considering an exceptional case that no wake-up event flag is set though a transition has been made to wake-up processing (usually, this never occurs in an independent operation of a microcomputer). However, if the user has written a user program so that it can deal with such an exceptional case, writing “0” to the break request control register 33 allows the CPU 22 to make a transition to a break state immediately after input of a break command.

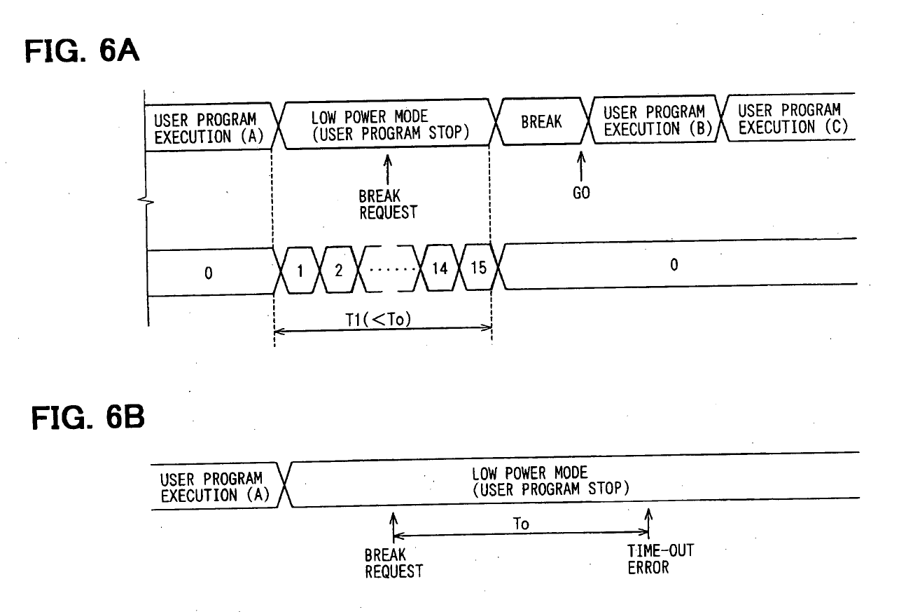

Next, the operation of the wake-up signal generation circuit 39 will be described with reference to timing charts of FIGS. 6A and 6B. FIG. 6A is a timing chart according to this embodiment, and FIG. 6B is a timing chart of a case that the wake-up signal generation circuit 38 is not provided.

Where the break reservation control is enabled, the CPU 22 cannot make a transition to a break state until occurrence of a certain wake-up event even if a break request signal is input in the low power consumption operation mode. However, there are microcomputer development assisting apparatus (ICES) in which a time from input of a break command to acceptance of the break is managed; a time out error occurs if a time out time To is exceeded as shown in FIG. 6B.

In view of the above, in this embodiment, a wake-up signal is generated forcibly and the CPU 22 makes a transition to a break state when a set time T1 (<To) has elapsed from a transition from the normal operation mode to the low power consumption operation mode. More specifically, when a transition has been made to the low power consumption operation mode, the counter 34 incrementally counts sub-clock pulses from “0.” when the count N has reached a set count N1 (in FIG. 6A, N1=15) corresponding to the set time T1, the comparator circuit 37 outputs a wake-up signal.

As a result, by making the set time T1 shorter than the time out time To, an internal wake-up event surely occurs within the time out time To of the ICE 11 and hence a transition to a break state can be made in response to a break request signal even if no ordinary wake-up event of a communication, input capture, or the like occurs. If after a transition to the low power consumption operation mode an internal wake-up event occurs without input of a break request signal or without generation of an ordinary wake-up signal in response to a communication, input at a terminal, or the like though a break request signal has been input, it is appropriate to return to the user program execution state, determine, on the basis of the wake-up event flags, that the CPU 22 has woken up due to an internal wake-up event, and again make a transition to the low power consumption operation mode.

### Other Embodiments

The invention is not limited the above illustrated embodiments, but following modifications are possible.

The setting information storage circuit is not limited to the operation setting register 29. For example, it may be a hardware circuit for storing a signal that is supplied to the evaluation chip 14 from a memory or the outside.

Where the functional circuit 26 is a timer, for example, a specific means that is used for the stop control circuit 30 to stop the progress of an operation of the functional circuit 26 may be such that a gate circuit is provided between the terminal of a clock CK and the timer (counter) and the gate circuit is opened or closed in accordance with an enable/disable signal from the stop control circuit 30.

The interface circuit 27 and the vector address switching circuit 28 may be provided independently of each other.

Each of the emulation memory 19 and the monitor program memory 20 may be a RAM or a flash memory and may be incorporated in the evaluation chip 14.

In the second embodiment, the counter 34 may start counting upon input of a break request signal in the low power consumption operation mode. The break request control register 33 need not always be provided and may be provided when necessary. The corresponding relationship between the value (0/1) of the break request control register 33 and disable/enable of the break reservation control may be opposite; that is, “0”, and “1” mean “enable” and “disable,” respectively.

What is claimed is:

1. A semiconductor integrated circuit device for emulating operation of a one-chip microcomputer having a CPU and a peripheral circuit that is controlled by the CPU, the device comprising:
a vector address switching circuit for outputting a vector address corresponding to a reset vector address supplied from the CPU when receiving a first reset signal, and for outputting a prescribed vector address instead of the vector address corresponding to the reset vector address supplied from the CPU when receiving a second reset signal; and
an interface circuit for performing input and output of information relating to emulation between the CPU and an external circuit,
wherein the CPU is constructed to be reset by the first and second reset signals and the interface circuit is constructed to be reset by the second reset signal.

2. The semiconductor integrated circuit device according to claim 1, wherein:
the peripheral circuit includes a functional circuit for realizing a primary function of the peripheral circuit, a stop control circuit for stopping, in response to reception, by the CPU, of a break request that has occurred during execution of an instruction by the CPU, progress of an operation of the functional circuit until completion of processing that is performed in response to the break request, and a setting information storage circuit for storing setting information indicating whether to enable or disable an operation stop function of the stop control circuit; and
the functional circuit of the peripheral circuit is constructed to be reset by the first and second reset signals, and the stop control circuit and the setting information storage circuit are constructed to be reset by the second reset signal.

3. The semiconductor integrated circuit device according to claim 1, further comprising:
an emulation memory for storing a user program; and
a monitor program memory for storing a monitor program.

4. The semiconductor integrated circuit device according to claim 1, wherein:
the CPU is operable in an normal operation mode and a low power consumption operation mode that is lower in power consumption than the normal operation mode; and
a break request control circuit is provided for causing a transition of the CPU to a break state after input of a wake-up signal for returning the CPU from the low power consumption operation mode to the normal operation mode when a break request signal is input externally in a period when the CPU is in the low power consumption operation mode.

5. The semiconductor integrated circuit device according to claim 4, wherein the break request control circuit is constructed to immediately output a break request signal to the CPU if the break request signal is input in a period when the CPU is in the normal operation rode, and outputs a break request signal to the CPU upon input of the wake-up signal if the break request signal is input in a period when the CPU is in the low power consumption operation mode.

6. The semiconductor integrated circuit device according to claim 4, further comprising;
a break request control register that is reset by the second reset signal,
wherein the break request control circuit is constructed to cause a transition of the CPU to the break state immediately or after input of the wake-up signal when the break request signal is input externally in a period when the CPU is in the low power consumption operation mode depending on a value of the break request control register.

7. The semiconductor integrated circuit device according to claim 4, further comprising:
a wake-up signal generation circuit for generating awake-up signal when a prescribed set time has elapsed from a transition of the CPU from the normal operation mode to the low power consumption operation mode.

8. The semiconductor integrated circuit device according to claim 7, wherein the wake-up signal generation circuit includes:
a counter for performing a counting operation in a period when the CPU is in the low power consumption operation mode;
a storage circuit for storing a set count corresponding to the set time; and
a comparator circuit for comparing a value of the counter with the set count of the storage circuit, and for outputting the wake-up signal when the value of the counter has reached the set count.

9. A microcomputer development assisting apparatus comprising:
a semiconductor integrated circuit device for emulating operation of a one-chip microcomputer having a CPU and a peripheral circuit that is controlled by the CPU in a state that the semiconductor integrated circuit device is electrically connected, in place of the one-chip microcomputer, to a circuit board to be mounted with the one-chip microcomputer; and
a host for setting a condition of emulation by the semiconductor integrated circuit device and for performing data processing on an emulation result,
wherein the semiconductor integrated circuit device includes
a CPU;
a peripheral circuit that is controlled by the CPU;
a vector address switching circuit for outputting a vector address of a user program corresponding to a reset vector address supplied from the CPU when receiving a first reset signal from the circuit board, and for outputting a vector address of a monitor program instead-of the vector address corresponding to the reset vector address supplied from the CPU when receiving a second reset signal from the host, and
an interface circuit for performing input and output of information relating to the emulation between the CPU and an external circuit,
wherein the CPU is constructed to be reset by the first and second reset signals and the interface circuit is constructed to be reset by the second reset signal.

10. The microcomputer development assisting apparatus according to claim 9, wherein:
the peripheral circuit includes a functional circuit for realizing a primary function of the peripheral circuit, a stop control circuit for stopping, in response to reception, by the CPU, of a break request that has occurred during execution of an instruction by the CPU, progress of an operation of the functional circuit until completion of processing that is performed in response to the break request, and a setting information storage circuit for storing setting information indicating whether to enable or disable an operation stop function of the stop control circuit; and
the functional circuit of the peripheral circuit is constructed to be reset by the first and second reset signals, and the stop control circuit and the setting information storage circuit are constructed to be reset by the second reset signal.

11. The microcomputer development assisting apparatus according to claim 9, wherein the semiconductor integrated circuit device further includes:
an emulation memory for storing a user program; and
a monitor program memory for storing a monitor program.

12. The microcomputer development assisting apparatus according to claim 9, wherein:
the CPU is operable in an normal operation mode and a low power consumption operation mode that is lower in power consumption than the normal operation mode; and
the semiconductor integrated circuit device further includes a break request control circuit for causing a transition of the CPU to a break state after input of a wake-up signal for returning the CPU from the low power consumption operation mode to the normal operation mode when a break request signal is input externally in a period when the CPU is in the low power consumption operation mode.

13. The microcomputer development assisting apparatus according to claim 12, wherein the break request control circuit is constructed to immediately output a break request signal to the CPU if the break request signal is input in a period when the CPU is in the normal operation mode, and outputs a break request signal to the CPU upon input of the wake-up signal if the break request signal is input in a period when the CPU is in the low power consumption operation mode.

14. The microcomputer development assisting apparatus according to claim 12, wherein:
the semiconductor integrated circuit device further includes a break request control register that is reset by the second reset signal; and
the break request control circuit is constructed to cause a transition of the CPU to the break state immediately or after input of the wake-up signal when the break request signal is input externally in a period when the CPU is in the low power consumption operation mode depending on a value of the break request control register.

15. The microcomputer development assisting apparatus according to claim 12, wherein the semiconductor integrated circuit device further includes a wake-up signal generation circuit for generating a wake-up signal when a prescribed set time has elapsed from a transition of the CPU from the normal operation mode to the low power consumption operation mode.

16. The semiconductor integrated circuit device according to claim 15, wherein the wake-up signal generation circuit includes:
a counter for performing a counting operation in a period when the CPU is in the low power consumption operation mode;
a storage circuit for storing a set count corresponding to the set time; and
a comparator circuit for comparing a value of the counter with the set count of the storage circuit, and for outputting the wake-up signal when the value of the counter has reached the set count.
